(19) United States
(12) Patent Application Publication
(10) Pub. No.: US 2017/0094346 A1
(43) Pub. Date: Mar. 30, 2017

(54) SYSTEMS AND METHODS FOR UTILIZING SMART TOYS WITH VEHICLE ENTERTAINMENT SYSTEMS

(71) Applicant: GM GLOBAL TECHNOLOGY OPERATIONS LLC, Detroit, MI (US)

(72) Inventor: AVINASH RUGOOBUR, SAN JOSE, CA (US)

(73) Assignee: GM GLOBAL TECHNOLOGY OPERATIONS LLC, Detroit, MI (US)

(21) Appl. No.: 15/312,150

(22) PCT Filed: May 22, 2015
(86) PCT No.: PCT/US2015/032238

§ 371 Date: Nov. 17, 2016

Related U.S. Application Data
(60) Provisional application No. 62/001,790, filed on May 22, 2014.

(51) Int. Cl. H04N 21/4363; H04N 21/414; H04N 21/422; H04N 21/41; B60N 2/48; H04W 76/02

(52) U.S. Cl. CPC H04N 21/43637; B60N 2/4876; H04W 76/02; H04N 21/4222; H04N 21/4126; H04N 21/41422

(57) ABSTRACT

A method of operating a rear seat entertainment system in a vehicle includes establishing a wireless data connection between the rear seat entertainment system and a smart toy provided within the vehicle; determining the type of the smart toy; and operating the rear seat entertainment system based on the type of the smart toy and user interaction with the smart toy.

### CROSS-REFERENCE TO RELATED APPLICATIONS

This application is a U.S. National-Stage entry under 35 U.S.C. §371 based on International Application No. PCT/US15/32238, filed May 22, 2015 which claims priority to Provisional Patent Application No. 62/001,790, filed May 22, 2014, the entire contents are hereby incorporated by reference.

### TECHNICAL FIELD

This application pertains to vehicle entertainment systems, and more particularly relates to interactive rear seat entertainment systems.

### BACKGROUND

Modern vehicles often incorporate one or more in-vehicle entertainment systems. One form of entertainment system that is particularly popular (especially with adults who transport children on a day-to-day basis) is the rear seat entertainment system (RSE), which typically includes one or more displays (such as touch-screen displays) viewable from the rear seating area. Such displays are often embedded in the head-rests of the front seats or mounted to the ceiling interior and are coupled to one or more media sources such as DVD players, game consoles, and the like.

Currently known entertainment systems may be unsatisfactory in a number of respects. For example, while DVD-based movies and television shows can provide a certain level of entertainment (particularly for small children, who are notorious for watching their favorite programs in nearly endless repetition), such programs are non-interactive and are generally not compelling or engaging to a child in the long term. Furthermore, to the extent that the entertainment system must be operated via a touchscreen, the child (particularly those secured in a child-seat) may have difficulty reaching the screen to access and control the entertainment experience. In addition, children increasingly have access to a wide and quickly changing array of entertainment choices, such as smart phones and tablet computers capable of playing thousands of easily downloadable applications, and can thus grow bored of the relative low interactivity provided by current entertainment systems. Finally, while a child might enjoy using a particular toy (such as a remote control truck) outside the vehicle, there is no motivation on the part of the child to bring that toy into the vehicle, as the play value of the toy is not enhanced (and is, in fact, greatly reduced) in a vehicle context.

Accordingly, it is desirable to provide a more compelling and engaging rear seat entertainment system that can be used in connection with toys that are typically used only in a non-vehicle context. Other desirable features and characteristics of the present invention will become apparent from the subsequent detailed description and the appended claims, taken in conjunction with the accompanying drawings and the foregoing technical field and background.

### DESCRIPTION OF THE DRAWINGS

The exemplary embodiments will hereinafter be described in conjunction with the following drawing figures, wherein like numerals denote like elements, and wherein:

FIG. 1 is a conceptual overview of a vehicle including a rear-seat entertainment system in accordance with various embodiments.

FIG. 2 is a conceptual block diagram of a system in accordance with various exemplary embodiments.

FIG. 3 is a flowchart of a method in accordance with an exemplary embodiment.

FIG. 4 is a flowchart of a method in accordance with an exemplary embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term “module” refers to an application specific integrated circuit (ASIC), an electronic circuit, a processor (shared, dedicated, or group) and memory that executes one or more software or firmware programs, a combinational logic circuit, and/or other suitable components that provide the described functionality.

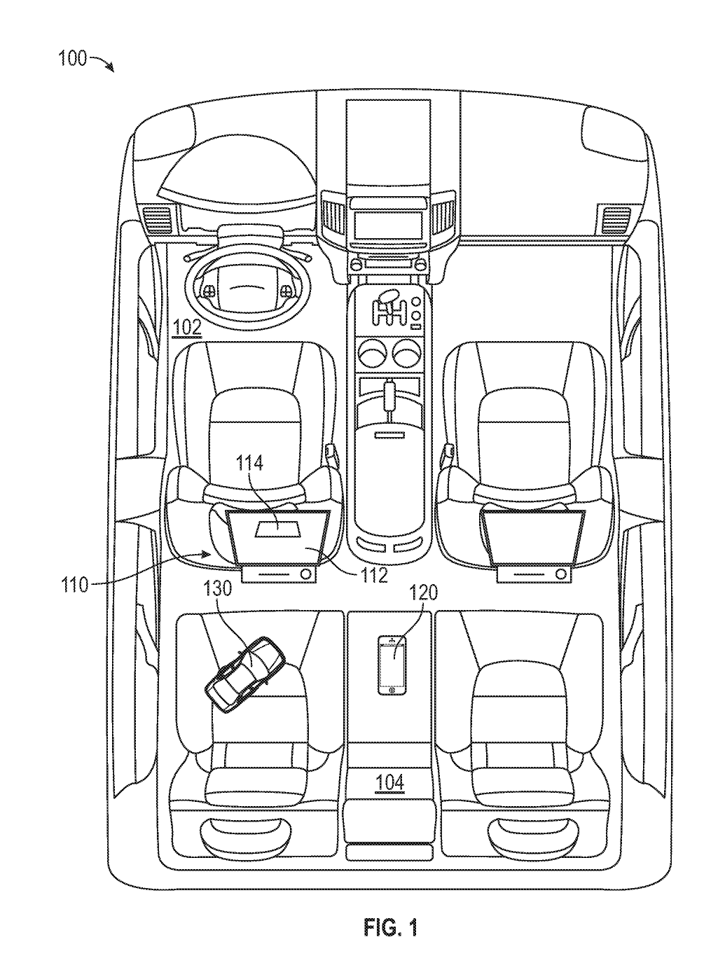

Referring to FIG. 1, in accordance with exemplary embodiments of the subject matter described herein a vehicle 100 includes a rear seat entertainment system (RSE) 110 having an in-vehicle, integrated display (or simply “display”) 112 for displaying video content, games, and/or other multimedia content (or simply “content” 114). As described in further detail below, RSE 110 is configured to auto-recognize that a smart toy 130 is present within the interior 102 of vehicle 100 (via, for example, RFID, Bluetooth communication, or the like), and smart toy 130 is configured to wirelessly communicate with RSE 110 (either directly or via an intermediary device such as a mobile device 120) such that RSE 110 is responsive to user interaction with smart toy 130. Stated another way, when present within interior 102, smart toy 130 becomes a human-machine interface (HMI) component of RSE 110. The user interaction proceeds in accordance with one or more applications (e.g., games, educational software, etc.) resident within and executed by one or more of RSE 110, mobile device 120, and smart toy 130.

The phrase “smart toy” as used herein generally refers to a toy (i.e., an object or collection of objects having some play value when used on its own) that utilizes integrated microprocessors, wireless interfaces, memories, storage devices, sensors (such as multi-axis accelerometers) and/or the like to provide a form of on-board “intelligence.” The phrase “smart toy” thus may be used interchangeably with the phrase “wirelessly coupled electronic entertainment object.” Such smart toys may have a wide range of capabilities and come in a wide variety of forms. For example, smart toy 130 may take the form of an automobile, an aircraft, a spacecraft, a boat, or any other mode of transportation. In other embodiments, smart toy 130 takes the form of an animal (e.g., a “plushy”), a humanoid, an alien life form, or any another simulacrum of a real or fanciful life form. In other embodiments, smart toy 130 takes the form of an inanimate object or an arbitrary, abstract shape. In some embodiments, smart toy 130 may be manipulated or otherwise instructed to take multiple forms (e.g., through mechanical transformation). In some embodiments, smart toy 130 is wearable—e.g., as headware, eyeware, or the like—and may monitor physiological data relating to the user. In many embodiments, as described in further detail below, the smart toy 130 has a baseline play value when used outside of vehicle 100 (e.g., a monster truck rolling around a playground) and an enhanced play value when used in conjunction with RSE 110 (e.g., as a controller that, when manipulated by a child, causes an animated monster truck on display 112 to roll over and crush cars in response to that manipulation).

The “smart toy” may refer to an object or article that has “some play value on its own,” and thus would exclude certain classes of objects such as video game controllers (e.g., a Wii Remote, XBox Controller, or Playstation Controller), whose entertainment value derives exclusively from its use in conjunction with the associated console. In other embodiments, “smart toy” refers to items that may not have some play value on its own (such as various wearable devices).

The phrase “rear seat entertainment system” and its initialism “RSE” are used herein without loss of generality. That is, neither RSE 110 nor its associated display 112 are required to be located in a rear seating area 104 of interior 102. Display 112, which might be implemented as a liquid-crystal (LCD) display or any other such suitable display type known in the art, is illustrated in FIG. 1 as located behind the driver's seat such that it is viewable from rear seating area 104; however, the size, shape, orientation, and position of display 112 may vary depending upon, for example, the vehicle type, geometrical constraints, and the like. For example, display 112 might be located centrally in a rear console or secured to an interior roof surface of the vehicle 100. Furthermore, while display 112 is described herein as “integrated” into the vehicle 100, in some embodiments display 112 might be removeably secured within the vehicle 100. As used in relation to display 112, the term “integrated” means that display 112 is configured to be used, in the ordinary course, as a part of the vehicle 100 (as opposed to, for example, mobile device 120). In accordance with various embodiments, display 112 is a touch-screen display that allows users in the vehicle 100 to interact with various subsystems of the vehicle 100 (including RSE 110) using a variety of user interface elements as is known in the art. Thus, RSE 110 includes any combination of hardware and software configured to provide entertainment (via display 112) to at least one user located in the vehicle 100. In a primary use-case, as mentioned above, the user being entertained is a child located in a child seat or otherwise secured in rear seating area 104.

As illustrated, one or more mobile devices 120 might be present within interior 102 of the vehicle 100, including, for example, one or more smart-phones, tablets, laptops, feature phones, or other the like. In accordance with exemplary embodiments, smart toy 130, mobile device 120, and/or RSE 110 may be communicatively coupled to each other in various combinations directly or through one or more intervening modules using a suitable wireless data connection, such as Bluetooth, Bluetooth Low Energy (BLE), radio frequency identification (RFID), near-field communication (NFC), IEEE 802.11 (WiFi), or the like. Such wireless communication protocols are well known, and need not be described in detail herein.

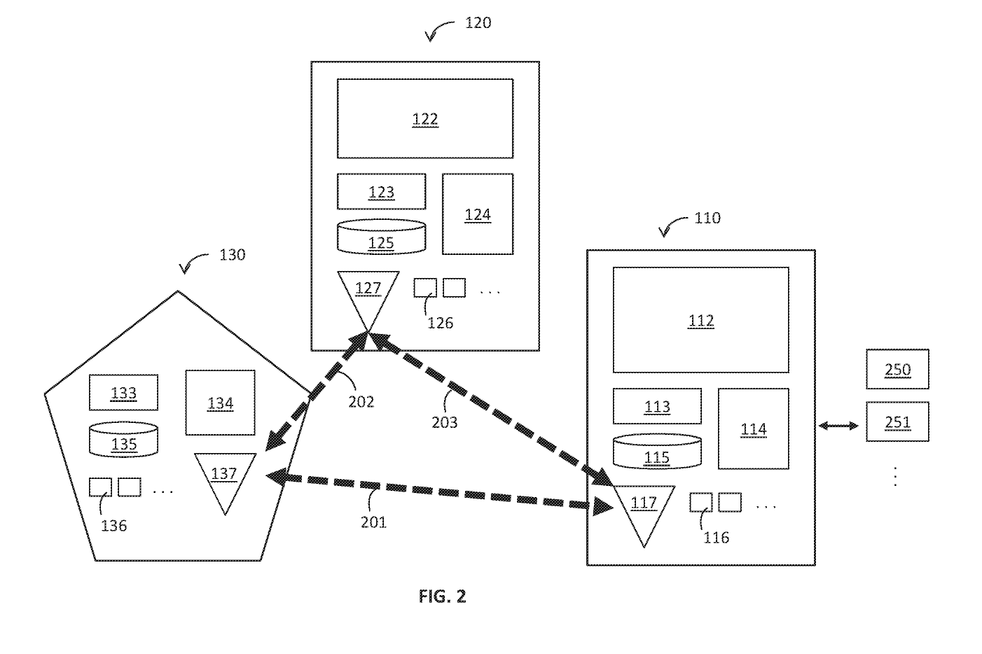

FIG. 2 provides a more detailed conceptual block diagram of the system illustrated in FIG. 1, and illustrates smart toy 130, mobile device 120, and RSE 110 intercommunicating using various wireless data communication channels 201, 202, and 203. Also illustrated are various external information sources 250, 251, etc., which might correspond, for example, to information related to the vehicle 100 (speed, position, and the like), information related to the environment, and any other information that might be available locally or over an available network.

As shown, RSE 110 generally includes a microprocessor (or controller) 114, a memory 113, storage 115 (e.g., solid state drive, micro-SD, or the like), display 112, and one or more wireless interfaces 117 (e.g., WiFi, Bluetooth, BLE, etc.). RSE 110 might also include various sensors 116. Similarly, mobile device 120, depending upon its capabilities, will also generally include a microprocessor 124, a memory 123, storage 125, various sensors 126, a display 122, and one or more wireless interfaces 127. Smart toy 130, in the illustrated embodiment, also generally includes a microprocessor 134, a memory 133, storage 135, various sensors 136 (e.g., one or more accelerometers, gyroscopes, physiological sensors, etc.), and one or more wireless interfaces 137 (e.g., WiFi, Bluetooth, BLE, etc.). Smart toy 130 may include various additional components (not illustrated in FIG. 2), such as one or more displays, one or more audio devices, various buttons or other input components, and the like.

A variety of information sources 250, 251 external to RSE 110 and smart toy 130 may be used by RSE 110 to enhance the entertainment value of smart toy 130. That is, RSE 110 (and the application being employed) may react differently based on the context of the vehicle 100, such as the vehicle's location, speed, etc. Such information may be provided by vehicle sensor data, mobile device sensor data (e.g., from sensors 126 of mobile device 120), and any available external information source (e.g., Internet data that is accessible through a vehicle telematics module or via paired mobile device 120). Vehicle sensor data might include, for example, basic vehicle information such as speed, acceleration, GPS position, as well as information generated by any of the numerous sensors such as temperature sensors, tire pressure sensors, and the like that are typically incorporated into modern vehicles. Such sensor information is, in modern vehicles, often transmitted over a vehicle's controller area network (CAN). Mobile device sensor data includes any sensor data available from mobile device 120, including, for example, multi-axis accelerometer data, gyroscope data, user health information and microphone data (e.g., to assist in determining the noise level in the vehicle). External information source includes any information available from a network remote from the car—e.g., information available from a server (such as a weather or traffic server) over the Internet or other network.

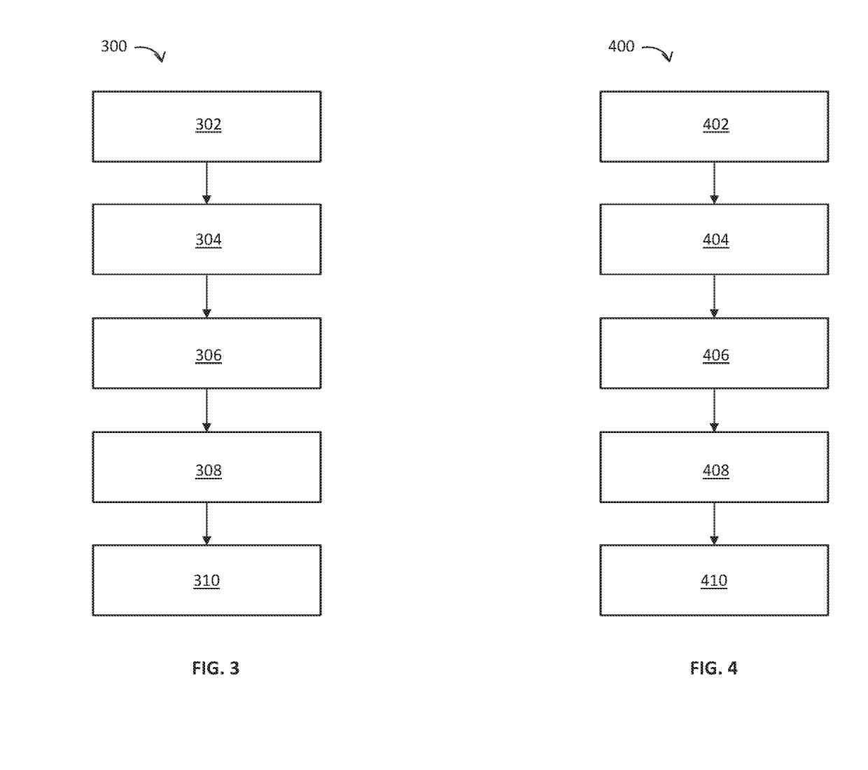

FIG. 3 is a flow chart depicting a method 300 in accordance with an exemplary embodiment in which smart toy 130 is wirelessly coupled directly to RSE 110. Referring to FIG. 3 in conjunction with FIG. 1, the method begins at 302 with smart toy 130 connecting to RSE 110 (establishing wireless connection 201) via respective wireless interfaces 117 and 137. This may be accomplished in accordance with a variety of protocols, as discussed above, and will generally include some form of discovery and/or handshaking process, as is known in the art. Next, at 304, RSE 110 auto-recognizes or otherwise determines the particular type of smart toy that has been brought into the vehicle, based on, for example, data (such as a unique identifier) transmitted to RSE 110 from smart toy 130. Next, at 306, RSE 110 configures display 112 and launches an application or applications (within microprocessor 114) based on the particular type of smart toy 130 that has been recognized. At this point (308), smart toy 130 can be used as a “controller” and interact with RSE 110 accordingly, as discussed in further detail below. Finally, at 310, information regarding the interaction taking place between RSE 110 and smart toy 130 during a session (in addition to vehicle data and any other appropriate external information source) may be sent to an external database for off-line interaction. For example, a particular drive of vehicle 100 may be recreated (at a smaller scale) such that the smart toy 130 can follow that path. In other embodiments, mobile device 120 acts as the display for use in connection with smart toy 130. Such an embodiment might be useful, for example, when vehicle 100 itself does not include a display, but RSE 110 is knows that mobile device 120 is in vehicle 100 and knows the display capabilities thereof.

FIG. 4 is a flow chart depicting a method in accordance with an exemplary embodiment in which RSE 110 communicates with smart toy 130 indirectly, through mobile device 120. Referring to FIG. 4 in conjunction with FIG. 1, the method begins at 402 with mobile device 120 connecting to RSE 110 (establishing wireless connection 203) via respective wireless interfaces 127 and 117. This may be accomplished in accordance with a variety of protocols, as discussed above. Next, at 404, mobile device 120 searches for an available smart toy and, if present, wirelessly connects thereto (via wireless connection 202). Mobile device 120 then recognizes the particular type of smart toy 130 that has been brought into the vehicle and RSE 110 configures display 112 and launches an application or applications (within microprocessor 124 and/or 114) based on the particular type of smart toy that has been recognized. In one embodiment, smart toy 130 sends a unique identifier encoded in a message passed to RSE 110 and or mobile device 120. Mobile device 120 and/or RSE 110 then parses this message and checks a list of available smart toys from a database, either locally or remotely. When RSE 110 and/or mobile device 120 finds a match, the appropriate devices are configured accordingly. At this point (408), smart toy 130 can be used as a “controller” and interact with RSE 110 accordingly, with communication being facilitated by mobile device 120. Finally, at 410, information regarding the interaction taking place between RSE 110, mobile device 120, and smart toy 130 during a session (in addition to vehicle data and any other appropriate external information source) may be sent to an external database and/or to mobile device 120 for subsequent off-line interaction.

Referring again to FIG. 2, the “brains” used to provide for interaction of smart toy 130 with RSE 110 may be provided by any combination of devices, depending upon, among other things, the availability and capabilities of RSE 110, mobile device 120, and smart toy 130. That is, the appropriate software application may be executed by RSE 110, by mobile device 120, by smart toy 130, or any combination thereof. Similarly, the appropriate software application may already be resident in one or more devices 110, 120, 130 or may be downloaded from one device to another or downloaded from an external network (e.g., a dedicated automotive “app store”).

What follows are a number of examples or “use-cases” depicting the various ways that RSE 110 and smart toy 130 may interact with each other. In that regard, the examples not meant to be limiting with respect to either the form of smart toy 130 or the behavior of RSE 110.

In accordance with one embodiment, smart toy 130 is a race car or other vehicle of a size that can be manipulated by a child, and display 112 of RSE 110 provides a street view (either fanciful or associated with the actual location of the vehicle 100) and other graphics (such as a graphical depiction of the smart toy) that is responsive to the motion of smart toy 130. That is, the child may “steer” the smart toy 130 to cause a corresponding steering motion of a graphic on screen 112. As RSE 110 knows the type of smart toy 130 that is being used (via an appropriate identifier), it can customize the rendered graphics accordingly. That is, if RSE 110 determines that smart toy 130 is a red car, the corresponding graphical component on screen 112 may be rendered as a red car.

In one embodiment, RSE 110 produces a graphical depiction that is responsive to the weather outside the vehicle. That is, display 112 might show rain on a race track when RSE 110 (through an external information source or other sensor) determines that the vehicle 100 is traveling through rain.

In one embodiment, RSE 110 produces a graphic that illustrate another vehicle on the screen such that the user may “race” against that vehicle. For example, the second vehicle might correspond to the vehicle 100 (i.e., the actual vehicle in which the user is riding).

In some embodiments, RSE 110 produces a graphical depiction that is responsive to areas of interest or other places that are near the actual vehicle 100 (as determined, for example, by GPS information). For example, when vehicle 100 is stopped at a gas station, display 112 might include a rendered gas station that smart toy 130 may interact with. In another example, when vehicle 100 is near the St. Louis Arch, display 112 might include a graphical depiction of the Arch and allow the rendered vehicle to travel under the arch.

In some embodiments, RSE produces educational content that is responsive to the location of vehicle 100. Various quizzes or the like may then be presented to the user to “unlock” certain rewards (such as different wheels for the displayed vehicle, etc.).

In some embodiments, smart toy 130 is configured to interact with mobile device 120 when smart toy 130 is used outside the vehicle 100. That is, smart toy 130 may be used as a controller for mobile device 120 just as it may be used with RSE 110.

In some embodiments, smart toy 130 may be used to control certain vehicle functions, such as the media player. That is, for example, smart toy 130 may be rotated to increase or decrease audio volume, shaken to change songs on an audio player, or manipulated to raise or lower the window (some predetermined distance).

In some embodiments, multi-player capability is provided between two or more smart toys 130 either in the same vehicle or in different vehicles communicatively coupled via an external network. Thus, for example, two or more users may engage in a “virtual race” using smart toys 130 as controllers.

In general, what has been described herein is a rear-seat entertainment system that provides a highly-personalized, engaging, and compelling experience for the user.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method of operating a rear seat entertainment system in a vehicle, the method comprising:
establishing a wireless data connection between the rear seat entertainment system and a smart toy provided within the vehicle;
determining the type of the smart toy; and
operating the rear seat entertainment system based on the type of the smart toy and user interaction with the smart toy.

2. The method of claim 1, wherein the wireless data connection system between the rear seat entertainment system and the smart toy is facilitated by an intermediary mobile device.

3. The method of claim 2, further including storing data associated with the operation of the rear set entertainment system in the intermediary mobile device.

4. The method of claim 1, further including operating the rear seat entertainment system based on an external information source.

5. The method of claim 4, wherein the external information source includes at least one of a data source relating to the state of the vehicle and a data source relating to the state of the environment associated with the vehicle.

6. The method of claim 1, further including transmitting data associated with operation of the rear seat entertainment system to a networked component remote from the vehicle.

7. The method of claim 1, wherein the rear seat entertainment system stores a plurality of applications, each associated with a corresponding type of smart toy, further wherein the rear seat entertainment system is operated in accordance with a first application selected from the plurality of applications based on the determination of the type of the smart toy.

8. A rear seat entertainment system for a vehicle comprising:
a processor;
a display coupled to the processor; and
a memory coupled to the processor and including software instructions configured to instruct the processor to:
establish a wireless data connection with a smart toy provided within the vehicle;
determine the type of the smart toy; and
operate the display of the rear seat entertainment system based on the type of the smart toy and user interaction with the smart toy.

9. The rear seat entertainment system of claim 8, wherein the wireless data connection system between the rear seat entertainment system and the smart toy is facilitated by an intermediary mobile device provided within the vehicle.

10. The rear seat entertainment system of claim 9, wherein the rear seat entertainment system is configured to instruct the mobile device to store data associated with the operation of the rear set entertainment system in the intermediary mobile device.

11. The rear seat entertainment system of claim 8, wherein the the rear seat entertainment system is operated based on an external information source.

12. The rear seat entertainment system of claim 11, wherein the external information source includes at least one of a data source relating to the state of the vehicle and a data source relating to the state of the environment associated with the vehicle.

13. The rear seat entertainment system of claim 8, wherein the processor is further configured to transmit data associated with operation of the rear seat entertainment system to a networked component remote from the vehicle.

14. The rear seat entertainment system of claim 8, wherein the rear seat entertainment system stores a plurality of applications, each associated with a corresponding type of smart toy, further wherein the rear seat entertainment system is operated in accordance with a first application selected from the plurality of applications based on the determination of the type of the smart toy.

15. A vehicle comprising:
an integrated display; and
a processor communicatively coupled to the integrated display, the processor configured to establish a wireless data connection with a smart toy provided within the vehicle; determine the type of the smart toy; and operate the integrated display based on the type of the smart toy and user interaction with the smart toy.

16. The vehicle of claim 15, wherein the wireless data connection is facilitated by a mobile device provided within the vehicle.

17. The vehicle of claim 15, wherein the integrated display is operated by the processor based on an external information source.

18. The vehicle of claim 17, wherein the external information source includes at least one of a data source relating to the state of the vehicle and a data source relating to the state of the environment associated with the vehicle.

19. The vehicle of claim 15, wherein the processor is further configured to transmit data associated with operation of the integrated display to a networked component remote from the vehicle.

20. The vehicle of claim 15, wherein the processor operates in accordance with software instructions downloaded over an external network in response to determining the type of smart toy
